(19) United States
(12) Patent Application Publication
(10) Pub. No.: US 2015/0131160 A1
(43) Pub. Date: May 14, 2015

(54) HEAD UP DISPLAY

(71) Applicants: Hyundai Motor Company, Seoul (KR); Kia Motors Corporation, Seoul (KR)

(72) Inventor: Hee Chon KWAK, Seoul (KR)

(73) Assignees: Kia Motors Corporation, Seoul (KR); Hyundai Motor Company, Seoul (KR)

(21) Appl. No.: 14/264,910

(22) Filed: Apr. 29, 2014

(30) Foreign Application Priority Data
Nov. 12, 2013 (KR) 10-2013-0137064

(51) Int. Cl. G02B 27/01

(52) U.S. Cl. CPC G02B 27/0149; G02B 2027/0159
USPC 359/631; 359/630

(57) ABSTRACT

A head up display includes an image source configured to generate an image or a video, a reflector configured to reflect the image or the video generated from the image source to a windshield glass. A rotating motor is configured to be interlocked with the reflector to control a height of the image or the video generated from the image source.

### CROSS-REFERENCE TO RELATED APPLICATION

This application claims the benefit of priority to Korean Patent Application No. 10-2013-0137064, filed on Nov. 12, 2013 in the Korean Intellectual Property Office, the disclosure of which is incorporated herein in its entirety by reference.

### TECHNICAL FIELD

The present disclosure relates to a head up display, and more particularly, to a head up display capable of controlling a height of an image which is irradiated to a windshield glass depending on a height or an eye level of a driver.

### BACKGROUND

Generally, a head up display is a system which displays a variety of car information on a windshield glass of a car as a virtual image to confirm the car information while a driver keeps an eye on the road while driving.

The head up display according to the related art is configured as illustrated in FIG. 1, and the head up display system includes an LCD 10, a mirror 11, and a controller 12.

Further, a video image displayed by the LCD 10, for example, a video image corresponding to a variety of car information received from an electronic control unit (ECU) within a car is reflected by the mirror 11 and then is projected onto the windshield glass in front of a driving seat.

As a result, the car driver may confirm the video image of the virtual image projected onto the windshield glass while the driver keeps his/her eye on the road while driving.

However, since the head up display according to the related art displays the image projected onto the windshield glass by fixedly projecting the image onto a previously set specific location, when a physical condition, a driving posture of a driver, and the like are peculiar, the driver may not accurately watch the image projected by the head up display system.

Further, according to the related art, a size and production cost of the head up display may be increased due to a top and bottom adjustment of an image output path by rotating a concave mirror.

### SUMMARY

The present disclosure has been made to solve the above-mentioned problems occurring in the prior art while advantages achieved by the prior art are maintained intact.

An aspect of the present disclosure provides a head up display to prevent an image from trembling and reduce a size and production cost of a head up display by controlling a height of the image projected onto a windshield glass depending on a height or an eye height of a driver and rotating a plane mirror having a size smaller than that of a concave mirror.

According to an exemplary embodiment of the present disclosure, a head up display includes an image source configured to generate an image or a video. A reflector is configured to reflect the image or the video generated from the image source to a windshield glass. A rotating motor is configured to be interlocked with the reflector to control a height of the image or the video generated from the image source.

The reflector may include a plane mirror configured to be rotatably mounted over the rotating motor, and a concave mirror configured to be fixedly mounted at the other side of the plane mirror.

The head up display may further include a rotating holder on which the plane mirror is supported, wherein the rotating holder may rotate by being interlocked with the rotating motor.

The head up display may further include a support on which the rotating holder is rotatably mounted.

Both ends of the plane mirror may be equipped with springs, and the springs may be fastened with the support.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating a head up display according to the related art.

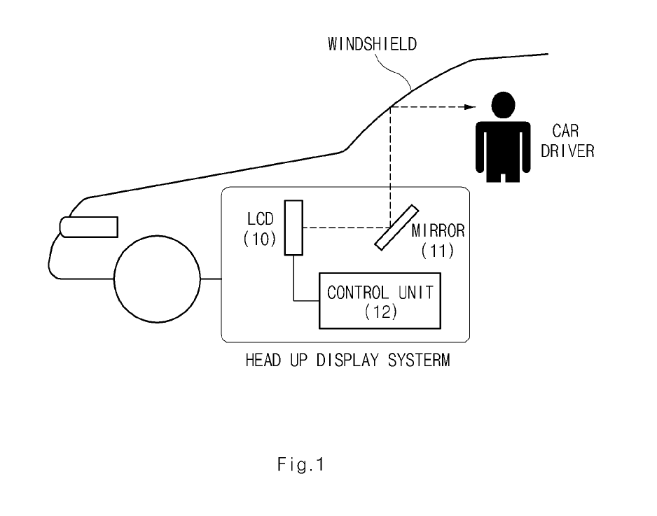

FIG. 2 is a diagram illustrating a head up display according to an exemplary embodiment of the present disclosure.

FIG. 3 is a diagram illustrating a rotating holder and a support equipped with a plane mirror in a head up display according to an exemplary embodiment of the present disclosure.

### DETAILED DESCRIPTION

Exemplary embodiments of the present disclosure will be described in detail with reference to the accompanying drawings.

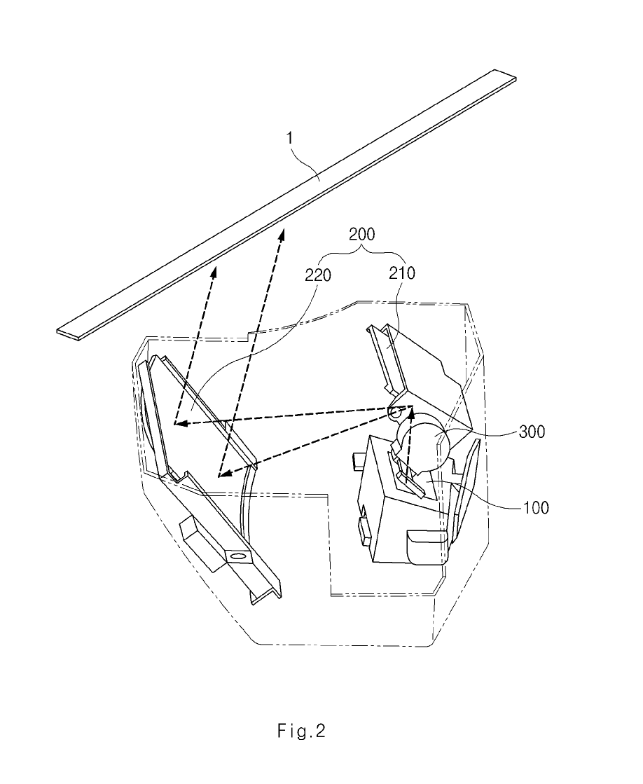

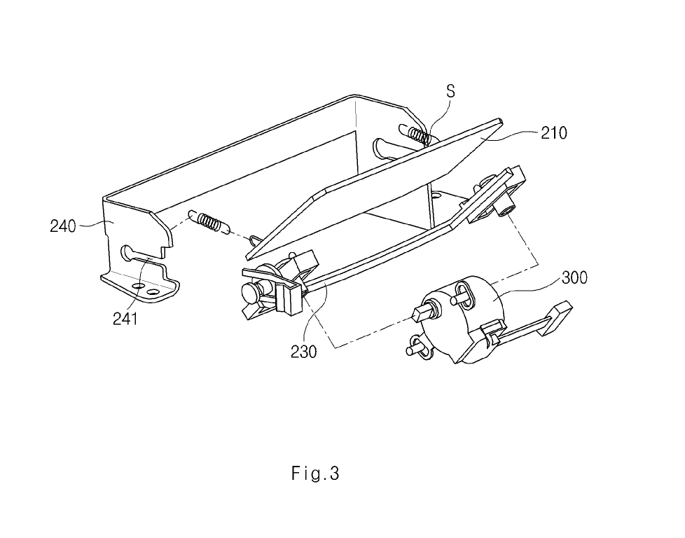

As illustrated in FIGS. 2 and 3, the head up display according to an exemplary embodiment of the present disclosure includes an image source 100 which generates an image or a video (hereinafter, video), a reflector 200 which reflects the image, and a rotating motor 300 which controls a height of the image.

The image source 100 receives and outputs an image signal from a separate display through a connection terminal.

Describing this in more detail, the image source 100 is connected to an electronic control unit (ECU) performing the overall electronic control functions within a car to receive a variety of car information on a travel speed, an engine state, and the like. When the image source 100 is connected to a display such as a navigation terminal, the image source 100 may also receive a variety of navigation information on a moving path to a specific destination.

The reflector 200 reflects the image generated from the image source 100 to a windshield glass 1 located in front of the car.

The rotating motor 300 is interlocked with the reflector 200 to control a height of the image output from the image source 100.

In this configuration, the reflector 200 is configured of a plane mirror 210 and a concave mirror 220, in which the plane mirror 210 is disposed at the rotating motor 300 side, and the concave mirror 220 is disposed at a location which is symmetrical with the plane mirror 210.

The plane mirror 210 is rotatably disposed over the rotating motor 300 to be able to reflect the image output from the image source 100 which is interlocked with the rotating motor 300.

The concave mirror 220 is fixed to the other side of the plane mirror 210 to second reflect the image of the image source 100 which is reflected from the plane mirror 210 and finally project the reflected image onto the windshield glass 1.

As such, the plane mirror 210 is disposed in the back of the windshield glass 1, and a reflective surface thereof is inclined toward the front. The concave mirror 220 is disposed in front of the windshield glass 1, and a reflective surface thereof is inclined toward the back. Thus, the image of the image source 100 may be projected onto the windshield glass 1 via the plane mirror 210 and the concave mirror 220.

The plane mirror 210 side is equipped with a rotating holder 230, so that the plane mirror 210 may be supported. The rotating holder 230 is interlocked with the rotating motor 300 to rotate at the time of operating the rotating motor 300, such that the plane mirror 210 may rotate.

Further, the rotating holder 230 may include a support 240 with which the rotating holder 230 is rotatably equipped. Both ends of the support 240 are provided with rotating holes 241, and thus, the rotating holder 230 may rotate, while being mounted in the rotating hole 241.

In this case, both ends of the plane mirror 210 is equipped with a spring S, and the spring S mounted in the plane mirror 210 is fastened with the support 240 to prevent trembling generated due to external vibrations.

As such, an exemplary embodiment of the present disclosure may vertically control the image output path by interlocking the rotating motor 300 with the plane mirror 210 to control the height of the image depending on the height and the eye height of the driver and since a size of the plane mirror 210 is smaller that of the concave mirror 220. When the rotating motor 300 rotates, the rotating radius becomes small, such that the overall size of the rotating may be reduced, thereby minimizing the volume of the part. Further, since the size of the plane mirror 210 is reduced, and the weight thereof is reduced, it is possible to prevent the image form trembling due to the external vibrations with the rotating torque of the small motor and the force of the spring, thereby saving the material cost and improving the productivity.

As set forth above, according to exemplary embodiments of the present disclosure, since the structure and the rotating radius are smaller at the time of rotating the plane mirror than at the time of rotating the concave mirror by using the plane mirror at the time of controlling the height of the image, the volume and the weight may be reduced. The motor torque and the spring force required to rotate the mirror may be reduced to reduce the noise occurrence at the time of rotating the mirror and prevent the image trembling phenomenon due to external vibrations, thereby improving marketability.

As described above, although the present disclosure has been described with reference to exemplary embodiments and the accompanying drawings, it would be appreciated by those skilled in the art that the present disclosure is not limited thereto, but various modifications and alterations might be made without departing from the scope defined in the following claims.

What is claimed is:

1. A head up display comprising:
an image source configured to generate an image or a video;
a reflector configured to reflect the image or the video generated from the image source to a windshield glass; and
a rotating motor configured to be interlocked with the reflector to control a height of the image or the video generated from the image source.

2. The head up display according to claim 1, wherein the reflector comprises:
a plane mirror configured to be rotatably mounted over the rotating motor; and
a concave mirror configured to be fixedly mounted at the other side of the plane mirror.

3. The head up display according to claim 2, further comprising:
a rotating holder on which the plane mirror is supported, wherein the rotating holder rotates by being interlocked with the rotating motor.

4. The head up display according to claim 3, further comprising:
a support on which the rotating holder is rotatably mounted.

5. The head up display according to claim 4, wherein both ends of the plane mirror are equipped with springs and the springs are fastened with the support.
